(19) United States
(12) Patent Application Publication
(10) Pub. No.: US 2026/0100437 A1
(43) Pub. Date: Apr. 9, 2026

(54) DOUBLE-WALL BATTERY ENCLOSURE TO PROVIDE HEAT TRANSFER

(71) Applicant: TI Group Automotive Systems, LLC, Auburn Hills, MI (US)

(72) Inventors: Jon HOLTZ, Auburn Hills, MI (US); Andrew SUTHERLAND, Auburn Hills, MI (US); Kit JONES, Coventry (GB); Albert BOECKER, Rastatt (DE)

(21) Appl. No.: 19/115,076

(22) PCT Filed: Sep. 26, 2022
(86) PCT No.: PCT/US2022/044680

§ 371 Date: Mar. 25, 2025

(51) Int. Cl. H01M 10/653; H01M 10/613; H01M 10/625; H01M 10/6556; H01M 10/6567; H01M 50/204; H01M 50/249

(52) U.S. Cl. CPC H01M 10/653; H01M 10/613; H01M 10/625; H01M 10/6556; H01M 10/6567; H01M 50/204; H01M 50/249; H01M 2220/20

(57) ABSTRACT

A double-wall enclosure for thermal management of a battery pack that includes an inner hollow structure having an internal and external surface; the inner hollow structure having one or more battery modules located therein; and an outer hollow structure having an interior surface, wherein the external surface of the inner hollow structure either contacts the interior surface of the outer hollow structure or forms at least one channel with the interior surface of the outer hollow structure through which a heat transfer fluid flows. The inner hollow structure is formed of a polymer material, such that the inner hollow structure is in thermal contact with the heat transfer fluid in order to provide for the thermal management of the battery pack.

### RELATED APPLICATIONS

The present disclosure claims priority to and is a national phase application of PCT Application PCT/US2022/044680, filed Sep. 26, 2022, the entire contents of which are incorporated herein by reference.

### FIELD

The invention relates to a battery enclosure for use in providing thermal management for a battery or battery module and/or a battery pack.

### BACKGROUND

The statements in this section merely provide background information related to the present disclosure and several definitions for terms used in the present disclosure and may not constitute prior art.

Currently, it is common in an electric vehicle (EV) or a hybrid electric vehicle (HEV) to provide heat transfer to/from the battery pack using an aluminum plate. This cooling plate is typically located at the bottom of the battery pack, which typically houses a plurality of batteries or battery modules. The cooling plate allows for the circulation of fluid there through for the purpose of heat transfer. Examples of the type of fluid generally used includes water or a water/glycol mixture. As the aluminum plate is electrically conductive, some form of polymeric pad or adhesive layer is generally located between the batteries in the battery pack and the cooling plate. Thus, this pad is in physical contact with both the battery and the cooling plate. The use of this pad also assists in eliminating any air gaps, which exist due to assembly tolerances and the roughness of the external surfaces for the batteries and the cooling plate. This pad or adhesive layer in combination with the aluminum plate may negatively impact the cost, assembly, recycling, and weight of the battery pack/cooling plate combination.

Another type of cooling plate can be formed using a film or composite foil as a flexible top layer in conjunction with a stiff lower plate. This film or composite foil has a very thin cross-section, which is on the order of 100 micrometers (μm) or less. The composite foil is inflated similar to a balloon by a fluid that is circulated there through. All contact forces exerted against the battery are achieved via this inflation technique. However, the performance and longevity of this type of cooling plate remains to be determined since the thin cross-section of the inflatable film is limited in its thermal conductivity and subject to tear. In addition, the thin film or composite foil may not be able to withstand the weight or dynamic forces exerted by the batteries that the film or foil attempts to support.

Finally, a third method of removing heat away from a battery has found limited use in some automotive hybrid vehicles, such as the McLaren Speedtail. This method includes surrounding the battery with a dielectric fluid. In this type of thermal management process, the dielectric fluid needs to be circulated or forced to flow to an external heat exchanger in order to remove the heat generated by the battery. In addition, the use of a dielectric fluid in this method relies upon the availability of a large quantity of such dielectric fluid and the cost associated therewith.

### SUMMARY

An objective of the present disclosure is to overcome the aforementioned disadvantages and to provide an improved battery enclosure for use in the thermal management of a battery or battery pack. In this respect, the present disclosure generally comprises a double-wall enclosure for battery thermal management. This double-wall enclosure comprises an inner hollow structure having an internal and external surface; the inner hollow structure having one or more battery modules located therein; and an outer hollow structure having an interior surface, wherein the external surface of the inner hollow structure either contacts the interior surface of the outer hollow structure or forms at least one channel with the interior surface of the outer hollow structure through which a heat transfer fluid flows. The inner hollow structure comprises a polymer material, such that the inner hollow structure is in thermal contact with the heat transfer fluid in order to provide for the thermal management of the battery pack. When desirable, the polymer material may comprise a thermally conductive polymeric material.

The inner hollow structure of the double-wall enclosure comprises a wall thickness that is in the range of about 0.3 millimeters (mm) to about 2.5 mm. In a similar fashion, the outer hollow structure comprises a wall thickness that is in the range of about 1 mm to about 5 mm.

A cavity may be formed between the one or more battery modules and the internal surface of the inner hollow structure. In this case, the cavity is at least partially filled with a heat transfer medium. This heat transfer medium, may include without limitation, a single phase dielectric fluid, a multiphase dielectric fluid, a phase change material, or a combination thereof.

The at least one channel formed between the inner and outer hollow structures may be located relative to the one or more battery modules either above, below, on at least one side, or a combination thereof. The heat transfer fluid that flows within the at least one channel may include, but not be limited to, water, a glycol, or a water/glycol mixture. The heat transfer fluid may be circulated to a radiator, a chiller, a heat exchanger, or the like.

The polymer material that forms the inner hollow structure may comprise an elastomer, a thermoplastic, a thermoplastic elastomer (TPE), or a combination thereof. When desirable, the polymer material may have a Shore A hardness that is in the range of about 40 to 100 or a Shore D hardness that is in the range of 20 to about 75. In general, the polymer material, when desirable to enhance thermal conductivity, may be a thermally conductive polymeric material. In general, a thermally conductive polymeric material may comprise a polymer having intrinsic thermal conductivity; a blend of polymers, wherein one or more of the polymers in the blend has intrinsic thermal conductivity; a composite polymeric material having at least one polymer configured as a polymeric matrix with a thermally conductive filler dispersed therein; or a combination thereof.

When the composition of the thermally conductive polymeric material comprises a composite polymeric material having a polymeric matrix with a thermally conductive filler dispersed therein, the thermally conductive filler may include a plurality of particles having a composition selected from the group consisting of boron nitride, alumina, aluminum nitride, silicon nitride, silicon carbide, graphene, carbon nanotubes, or a mixture thereof. The polymeric matrix may be an elastomer, a thermoplastic, or a thermoplastic elastomer (TPE) having a Shore A hardness that is in the range of about 40 to 100 or a Shore D hardness that is in the range of 20 to about 75. Alternatively, the composition of the composite polymeric material comprises a plurality of boron nitride particles dispersed in a thermoplastic elastomer (TPE) having a Shore A hardness in the range of about 70 to about 80. The thermally conductive filler comprises between about 5 wt. % to about 25 wt. % of the overall weight of the composite polymeric material.

The composition of the outer hollow structure may comprise any standard or known polymer composition capable of providing structural support to the battery pack. This polymer composition may include, without limitation, high density polyethylene (HDPE), polypropylene (PP), polyamide (PA), or a combination thereof either as copolymers, a polymeric blend/mixture or as a multi-layered structure or composite.

According to one aspect of the present disclosure, the inner hollow structure may include one or more structural elements configured to support the weight of the battery or act as a bump stop configured to assist in battery placement and retention. These structural element(s) may have a composition that is the same or different from the composition of the inner hollow structure. In addition, these structural element(s) may be either formed integrally with the inner hollow structure or formed as an insert that is joined with the inner hollow structure.

According to another aspect of the present disclosure, when desirable, at least one of the external surface of the inner hollow structure or the interior surface of the outer hollow structure may include one or more features configured to increase stiffness and to promote fluid mixing by directing the flow of the fluid. These features may protrude into at least one of the channel(s). However, at least a portion of the external surface of the inner hollow structure that forms a part of the at least one channel is flat, such that at least 50% surface contact is maintained with the heat transfer fluid in the at least one channel. The inner hollow structure and the outer hollow structure results in less than about 15% volume change upon allowing the heat transfer fluid to flow through the at least one channel.

According to another aspect of the present disclosure, a battery pack with thermal management is provided. This battery pack comprises at least one battery module and a double-wall enclosure that includes an inner hollow structure and an outer hollow structure as previously described above and further defined herein.

According to another aspect of the present disclosure, the double-wall enclosure may be used to provide for thermal management of at least one battery in an electric vehicle (EV) or hybrid electric vehicle (HEV).

According to yet another aspect of the present disclosure, a process of forming a battery pack configured for thermal management is provided. This process comprises: providing a polymer material; molding an inner hollow structure from the polymer material, this inner hollow structure has an external and internal surface; molding an outer hollow structure having an interior surface that surrounds the external surface of the inner hollow structure, wherein the external surface of the inner hollow structure either contacts the interior surface of the outer hollow structure or forms at least one channel with the interior surface of the outer hollow structure; providing at least one battery; assembling the at least one battery in the inner hollow structure with one or more cavities being formed between the battery and the internal surface of the inner hollow structure; filling the one or more cavities with a heat transfer medium, and allowing a heat transfer fluid to flow through the at least one channel located between the interior surface of the outer hollow structure and the external surface of the inner hollow structure. The molding process utilized in this process may be selected as one from the group consisting of blow molding, injection molding, compression molding, rotational molding; or a combination thereof.

When desirable this process may further comprise forming one or more structural elements present in the inner hollow structure in order to assist in supporting the weight of the batteries or battery modules or to act as a bump stop for the placement and retention of such batteries. These structural elements may be formed by a molding process, such as for example, blow molding utilizing “Ship-in-a-Bottle (SIB)” technology or “Tank Advanced Process Technology (TAPT)”.

When desirable the process may further comprise forming one or more features that protrude into the at least one channel from the interior surface of the outer hollow structure or from the external surface of the inner hollow structure, in order to increase stiffness and/or to promote fluid mixing by directing the flow of the fluid.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings. The components in each of the drawings may not necessarily be drawn to scale, but rather emphasis is placed upon illustrating the principles of the invention.

FIG. 1A is a schematic representation showing a cut-away peripheral view of a battery pack containing a battery within a double-wall enclosure formed according to the teachings of the present disclosure.

FIG. 1B is a cross-sectional view of the battery pack and enclosure of FIG. 1A taken along axis x.

FIG. 2A is a cross-sectional view of another battery pack formed according to the teachings of the present disclosure.

FIG. 2B is a cross-section view of yet another battery pack formed according to the teachings of the present disclosure.

FIG. 3 is a cross-sectional view of another battery pack and enclosure similar to that shown in FIG. 1B, wherein one or more structural supports are provided in the structure of the double-wall enclosure.

FIG. 4A is a schematic representation showing a cut-away peripheral view of a battery pack containing a battery within another double-wall enclosure formed according to the teachings of the present disclosure.

FIG. 4B is a cross-sectional view of the battery pack and enclosure of FIG. 4A taken along axis x.

FIG. 5 is a perspective cut-away view of a section of an enclosure highlighting the flow of fluid through features protruding into one or more channels of the enclosure.

FIG. 6 is a flowchart of a process used to form a battery pack containing a battery within a double-wall enclosure according to the teachings of the present disclosure.

The drawings are provided herewith for purely illustrative purposes and are not intended to limit the scope of the present invention.

### DETAILED DESCRIPTION

The following description is merely exemplary in nature and is in no way intended to limit the present disclosure or its application or uses. For example, the battery enclosure made and used according to the teachings contained herein is described throughout the present disclosure in conjunction with the thermal management of a battery or battery pack in an electric vehicle (EV) or a hybrid electric vehicle (HEV) in order to more fully illustrate the structural elements and the use thereof. The incorporation and use of such a battery enclosure in other applications, including without limitation, in other electric equipment or devices that utilize a battery or battery pack is contemplated to be within the scope of the present disclosure. In addition, other power electronics devices, such as metal oxide semiconductor field effect transistors (MOSFETs), gate turn-off thyristors (GTOs), insulated-gate bipolar transistors (IGBTs), and integrated gate-commutated thyristors (IGCTs), which are widely accepted for efficient delivery of electrical power in home electronics, industrial drives, telecommunication, transport, electric grid, and numerous other applications, may greatly benefit from the double-wall enclosure concept set forth herein. It should be understood that throughout the description and drawings, corresponding reference numerals indicate like or corresponding parts and features.

As used herein a “battery cell” refers to the basic electrochemical unit of a battery that contains an anode and a cathode, as well as any components used to convert stored chemical energy to electricity, such as, for example, electrodes, a separator, and an electrolyte. In comparison, a “battery” or “battery module” refers to at least one battery cell placed within a housing with electrical connections and possibly electronics for control and protection. A “battery pack” refers to a collection of more than one battery, in other words a plurality of battery modules, connected either in series or parallel to one another in order to increase the voltage or capacity arising therefrom with the collection of batteries being secured within a housing.

Within this specification, embodiments have been described in a way which enables a clear and concise specification to be written, but it is intended and will be appreciated that embodiments may be variously combined or separated without departing from the invention. For example, it will be appreciated that all preferred features described herein are applicable to all aspects of the invention described herein.

The present disclosure provides a double-wall enclosure for battery thermal management. This double-wall enclosure generally comprises an inner hollow structure that houses one or more battery modules and an outer hollow structure that surrounds or encompasses the inner hollow structure. One or more cavities are formed between the batteries and the internal surface of the inner hollow structure. Similarly, at least one channel is formed between the external surface of the inner hollow structure and the outer hollow structure. This at least one channel is configured to allow a heat transfer fluid to flow there through in order to provide for the thermal management of the batteries. The at least one channel may be located above the batteries, below the batteries, on one or more sides of the batteries, or a combination thereof.

During operation, the cavities between the batteries and the internal surface of the inner hollow structure may be filled with a heat transfer medium. In addition, the at least one channel comprises a heat transfer fluid flowing there through. The heat generated from the batteries is transferred by the heat transfer medium to and through the inner hollow structure to the heat transfer fluid flowing in the at least one channel located between the inner and outer hollow structures.

The heat transfer medium, may include without limitation, a single phase dielectric fluid, a multiphase dielectric fluid, a phase change material, or a combination thereof. The phase change material may include, but not be limited to, a paraffin, a sugar alcohol, a salt hydrate, or a mixture thereof. Several examples of a single phase dielectric fluid include, without limitation, Kryo 51 and Kryo 20 (LAUDA Dr. R. Wobser GmbH & Co. KG, Germany) or Xenitron 3221 (Croda International PLC, United Kingdom). An example of a multi-phase dielectric fluid includes, without limitation, Novec 7000 (the 3M Company, United States). In preferred designs for the inner hollow structure, the amount of heat transfer medium necessary to fill the cavities may be minimized due to the cost and weight associated with such a medium. One skilled in the art will understand that although most designs for the double-wall enclosure of the present disclosure may describe this heat transfer medium as being stationary, it is possible to circulate or cause this heat transfer material to flow without exceeding the scope of the present disclosure.

The heat transfer fluid may include heat transfer material that is a liquid at typical ambient temperatures. The heat transfer fluid may comprise, without limitation, water, a glycol, or a glycol/water mixture.

In order to facilitate the transfer of heat from the heat transfer medium to the heat transfer fluid, the inner hollow structure generally comprises a polymer material such that the inner hollow structure is in thermal contact with the heat transfer fluid in order to provide for the thermal management of the battery pack. The polymer material may comprise an elastomer, a thermoplastic, a thermoplastic elastomer (TPE), or a combination thereof. The TPE used as the polymer material may comprise, without limitation styrenic block copolymers (TPE-S), polyolefin blends (TPE-O), thermoplastic polyurethanes (TPE-U), thermoplastic copolyesters (TPE-E), thermoplastic polyamides (TPE-A), or a mixture thereof. Alternatively, the thermoplastic used as the polymer material may be, without limitation, high density polyethylene (HDPE), polypropylene (PP), polyamide (PA), polyethylene terephthalate (PET) or a mixture thereof. The polymer material is selected based on a combination of properties, including but not limited to hardness, cost, environmental impact, and the processing method available to form the inner hollow structure. The type of polymer material selected for a given application may affect the wall thickness of the inner hollow structure in order to achieve the necessary compliance to provide the required or desired contact with the batteries, the heat transfer fluid, and/or the outer hollow structure.

When desirable, the polymer material may have a Shore A hardness that is in the range of about 40 to 100 or a Shore D hardness that is in the range of 20 to about 75. In order to enhance thermal conductivity, the polymer material may be a thermally conductive polymeric material. In general, the thermally conductive polymeric material may comprise a polymer having intrinsic thermal conductivity; a blend of polymers, wherein one or more of the polymers in the blend has intrinsic thermal conductivity; a composite polymeric material having at least one polymer configured as a polymeric matrix with a thermally conductive filler dispersed therein; or a combination thereof.

Polymers having intrinsic thermal conductivity may be used alone, in a blend with other polymers, or as at least a portion of the polymeric matrix that forms part of a composite polymeric material. Several examples of thermally conductive polymeric materials may include, without limitation, thermally conductive epoxy resins, polyimide (PI), polyoxymethylene (POM), polycarbonate (PC) or other high-performance engineering polymers. When desirable, the thermally conductive polymeric materials may include, but not be limited to, conjugated polymers having a rigid conjugated backbone and strong intermolecular TT-IT stacking interactions, such as, for example, diamine cured epoxy resins having a liquid crystalline structure containing biphenyl functional groups. The intrinsic thermal conductivity of the thermally conductive polymer materials may be enhanced upon the formation of specific physical structures based on crystallinity, crystal grain size, grain (crystallite) orientation, molecular chain length, degree of which amorphous regions connect the crystallites, etc. or by tailoring the structure of polymer chain functionality during polymer synthesis and processing.

When the thermally conductive polymeric material used to form the inner hollow structure is a composite polymeric material having a thermally conductive filler dispersed within a polymeric matrix, the polymeric matrix provides a relatively soft and flexible composite polymeric material that allows for efficient heat transfer. In this respect the thermally conductive filler enables good thermal conductivity, while the polymeric matrix is sufficiently soft and flexible to directly eliminate gaps and provide for good physical contact between the surface of the inner hollow structure and the batteries located therein, as well as the heat transfer medium that fills any cavities formed therein. Alternatively, the polymeric matrix may be a harder polymeric material, such as high density polyethylene (HDPE) or polypropylene (PP), in this case the heat transfer medium fills any cavities formed therein, providing good contact and heat transfer. Since the thermally conductive filler may also exhibit low electrical conductivity, the use of the composite polymeric material may also effectively provide for electrical insulation of the battery pack.

In addition, upon allowing the heat transfer fluid to flow through the one or more channels between the inner and outer hollow structures, the materials used to form the inner and outer hollow structures may change its volume by 20% or less; alternatively, less than 15%; alternatively, about 10% or less; alternatively, no greater than 5%.

Although the double-wall enclosure of the present disclosure is not as thermally conductive as a conventional, commercially available, aluminum cooling plate, the thermal conductivity provided by the polymer material of the inner hollow structure along with the presence of the heat transfer medium and the heat transfer fluid is capable of providing the performance necessary or desired for the thermal management of a battery pack whilst also directly providing the required electrical insulation, rather than needing an additional insulating layer as required with the use of a conventional aluminum cooling plate. In addition, the double-wall enclosure formed according to the teachings of the present disclosure provides the additional advantages over conventional cooling plates of being less expensive to manufacture, lighter in weight, easier to assemble, a reduced chance for the occurrence of a short circuit within the battery pack, and in some cases, even easier to recycle (e.g., as compared to the use of an adhesive layer and polymer pad). The process of forming the double-wall enclosure opens up the commercial feasibility of producing a product for small volume markets due to the need for lower investment costs, which are driven by the differences that exist in tooling in comparison to the manufacturing processes associated with conventional cooling plates.

For the purpose of this disclosure, the terms “about” and “substantially” as used herein with respect to measurable values and ranges refer to the expected variations known to those skilled in the art (e.g., limitations and variability in measurements).

For the purpose of this disclosure, the terms “at least one” and “one or more of” an element are used interchangeably and may have the same meaning. These terms, which refer to the inclusion of a single element or a plurality of the elements, may also be represented by the suffix “(s)” at the end of the element. For example, “at least one channel”, “one or more channels”, and “channel(s)” may be used interchangeably and are intended to have the same meaning.

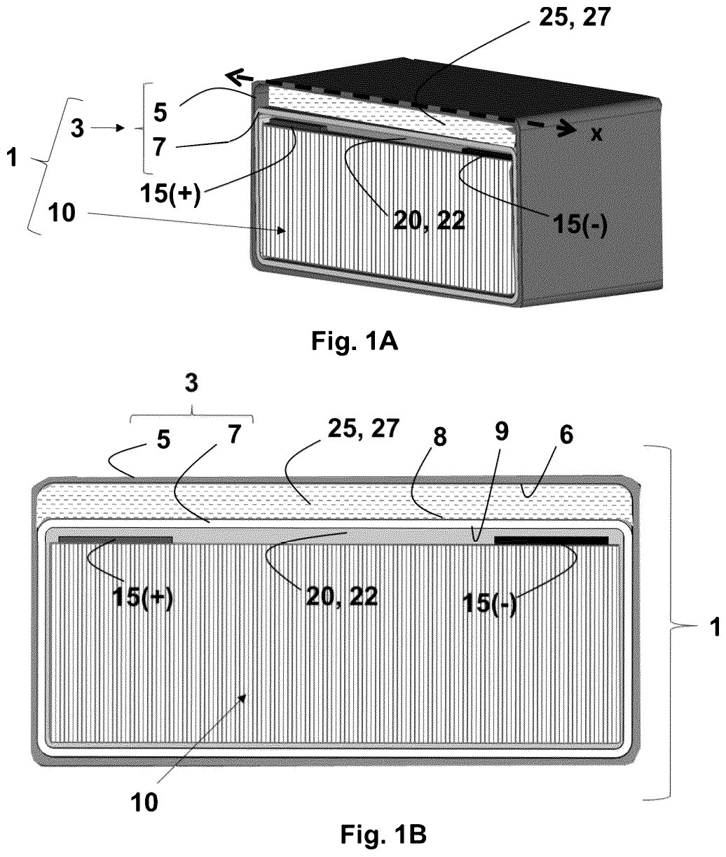

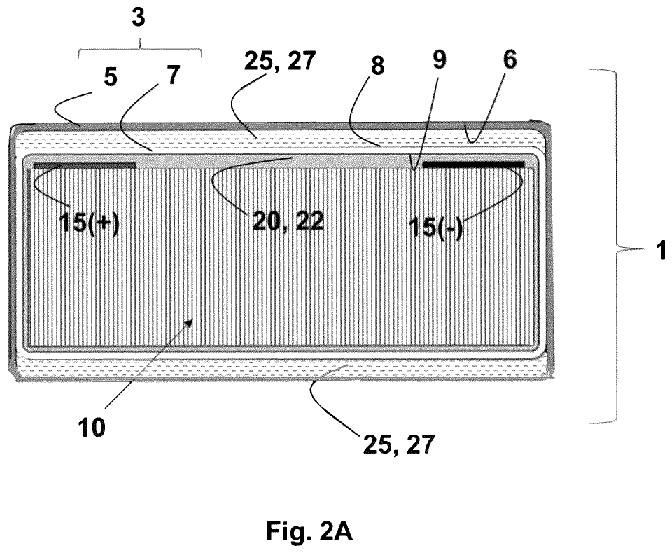

Referring now to FIG. 1A and FIG. 1B, a battery pack 1 is shown with one or more battery modules 10, each having a positive 15(+) and negative 15(−) terminal positioned in a double-wall enclosure 3. In FIG. 1B, the battery pack of FIG. 1A is shown as a cross-section taken along axis x. The double-wall enclosure 3 generally comprises an inner hollow structure 7 or housing and an outer hollow structure 5 or housing that surrounds or encompasses the inner hollow structure 7. The one or more battery modules 10 are located within the inner hollow structure 7. One or more cavities 20 may be formed between the batteries 10 and the internal surface 8 of inner hollow structure 7 may be filled with a heat transfer medium 22. The one or more cavities 20 may exist partially around the entire battery 10 or as shown in FIG. 1B, around the entire circumference of the battery 10. In addition, at least one channel 25 is formed between the external surface 9 of inner hollow structure 7 and the interior surface 6 of the outer hollow structure 5. This at least one channel 25 may be filled with a heat transfer fluid 27.

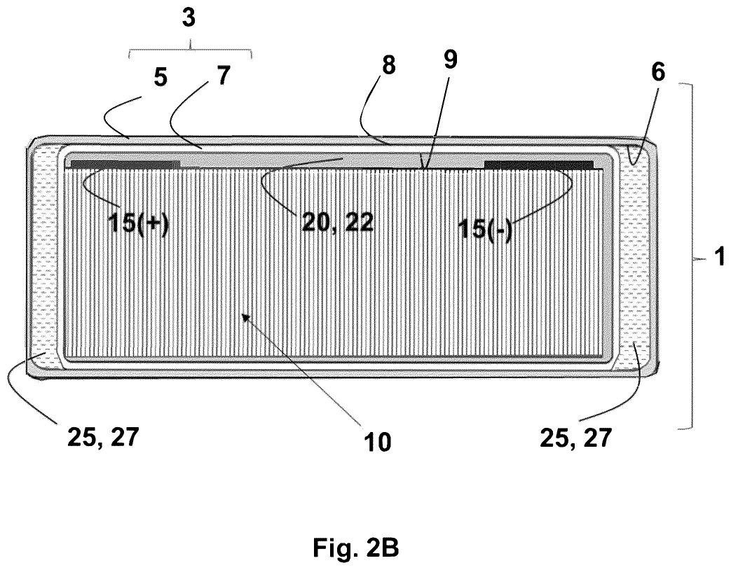

As shown in FIG. 1A and FIG. 1B, in order to more fully illustrate the structure of the double-wall enclosure 3 and the use thereof, the at least one channel 25 is depicted in most of the figures herein as being located above the batteries 10 or battery modules 10. In locations between the inner and outer hollow structures 5, 7 where a channel 25 does not exist, the outer surface 8 of the inner hollow structure 7 contacts the interior surface 6 of the outer hollow structure 5. However, referring now to FIG. 2A, the at least one channel 25 may be turned upside down, such that the at least one channel 25 is located below the batteries 10 or battery modules 10, or both above and below the batteries 10. In a similar fashion, as shown in FIG. 2B, when necessitated by or desired for a particular application the at least one channel 25 may be located on one or more sides of the batteries 10 or battery modules 10 within the battery pack 1. Thus, the at least one channel 25 may be located above, below, on one or more sides of the batteries 10, or any combination thereof without exceeding the scope of the present disclosure.

Still referring to FIGS. 1A, 1B, 2A, and 2B, the use of a polymer material to form the inner hollow structure 7 provides sufficient capability for the interior surface 9 of the inner hollow structure 7 to conform to and establish contact with the batteries 10, overcoming any surface roughness or unevenness that may inherently exist and/or to fully contact the heat transfer medium 22 present in any cavities 20 formed there between. In addition, the exterior surface 9 of the inner hollow structure 7 is able to maintain at least 50% surface contact with the heat transfer fluid 27 in the at least one channel 25 located between the inner and outer hollow structures 5, 7. Alternatively, the inner hollow structure 7 maintains between 50% and 100% surface contact with the heat transfer fluid 27; alternatively, greater than 50% and less than 100%; alternatively, between 55% and 95%; alternatively, about 60% to about 90%. For the purpose of the present disclosure, the term “between” is intended to include the limits specified for the stated range.

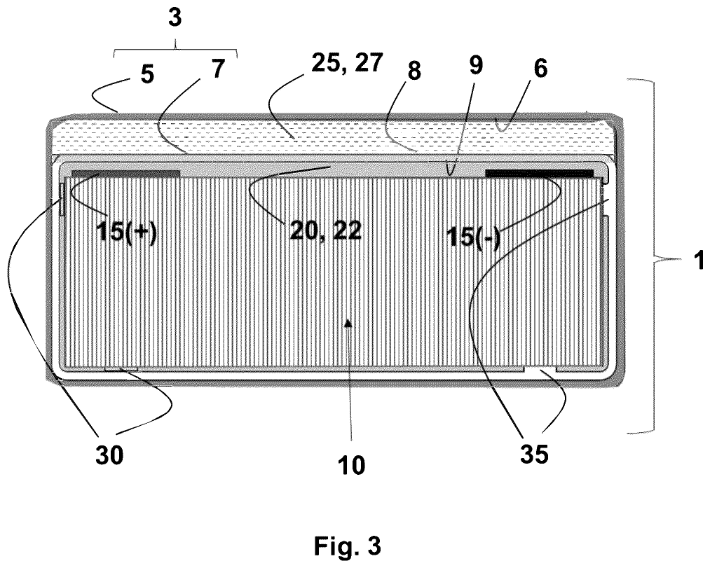

Referring now to FIG. 3, the inner hollow structure 7 may include one or more structural elements 30, 35 configured to support the weight of the battery or to act as a bump stop configured to assist in battery placement and retention. These structural element(s) 35 may have a composition that is the same as the composition of the inner hollow structure 7. Alternatively, the structural element(s) 30 may have a composition that is different than the composition of the inner hollow structure 7. The structural element(s) 30, 35 may be either formed integrally with the inner hollow structure or formed as an insert that is then joined to the inner hollow structure 7.

For the purpose of this disclosure, the term “integrally formed” or “formed integrally” is meant to imply that the structural element(s) 35 and the inner hollow structure 7 are formed or molded as a single component and/or that the structural element(s) 30 and the inner hollow structure 7 are formed separately and then joined together to form a “leak-free” hollow structure 7 through the use of one more of ultrasonic welding, spin welding, vibration welding, hot plate welding, infrared welding, laser welding, and over-molding processes. Alternatively, the structural element(s) 35 are formed as a single component. Any process known to one skilled in the art that can form a single component from a polymer material may be utilized, such as for example, without limitation, injection molding or blow molding. In a similar fashion, the inner hollow structure 7 and the outer hollow structure 5 may be integrally formed, without limitation, through the use of techniques, such as the “Ship-in-a-Bottle” (SIB) technique or “Tank Advanced Process Technology” (TAPT) performed via blow molding. Additional information regarding SIB or TAPT may be found in U.S. Publication No's. 2005/0040566A1, 2005/0040567A1, and 2021/0379811A1, wherein the entire contents of each are incorporated herein by reference. The use of TAPT provides the additional advantage in that the battery pack is not exposed to heat during the blow mold process.

The inner hollow structure 7 is formed with a wall thickness that is in the range of about 0.3 millimeters (mm) to about 2.5 mm. Alternatively, the wall thickness may in the range of about 0.5 mm to about 2.3 mm; alternatively, about 1.0 mm to about 2.0 mm. Similarly, the wall thickness of the outer hollow structure 5 is in the range of about 1.0 mm to about 5.0 mm; alternatively, about 1.5 mm to about 4.0 mm in order to provide structural integrity to the double-wall enclosure 3. The wall thickness of the top, the bottom, and/or the sides of the inner hollow structure 7 and/or the outer hollow structure 5 may be the same or different depending upon the structural design and manufacturing parameters utilized for a given application. For example, the selection of the wall thickness may vary depending upon the thickness necessary to provide adequate stiffness to support the weight of the batteries and to maintain a stress level in the structure of the inner and/or outer hollow structures 5, 7 that is below the yield stress of the material(s) used to form the structures 5, 7.

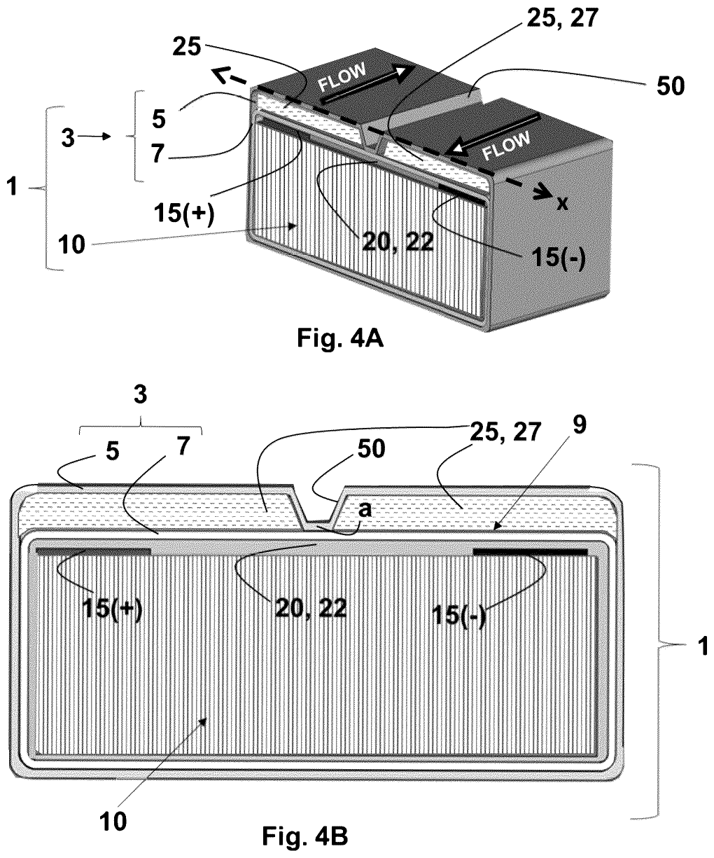

Referring now to FIGS. 4A and 4B, a battery pack 1 similar to that shown in FIG. 1A and FIG. 1B is provided in which at least one angled structural support 50 divides the channel(s) 25, such that the fluid transfer fluid 27 flows in multiple directions. One skilled in the art will understand that solid structural supports may be utilized instead of angled structural supports 50 without exceeding the scope of the present disclosure. However, such an angled structural support 50 design may be desirable depending upon the type of process (e.g., for example, blow molding, etc.) selected for use in forming the external hollow structure 5. The use of an angled structural support 50 design creates a small area (a) in which there will be very limited heat transfer occurring due to the lack of thermal contact between the external surface 9 of the inner hollow structure 7 and the heat transfer fluid 27. The existence of this small area (a) will not affect the performance of the double-wall enclosure 3 in providing for the thermal management of the batteries 10.

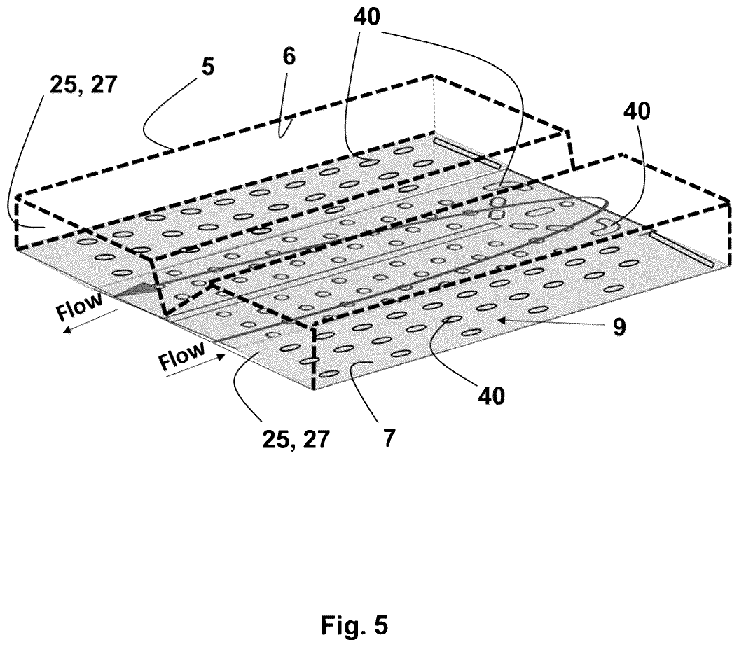

Referring now to FIG. 5, a cut-away view of the battery pack 1 in the area of the channel(s) 25 of FIG. 4A and FIG. 4B is shown. In FIG. 5, the contour of the external surface 9 of the inner hollow structure 7 is shown with at least one feature 40 arising therefrom and protruding into the at least one channel 25 in order to provide additional stiffness and to direct or control the flow of the heat transfer fluid 27. One skilled in the art will understand that these feature(s) 40 may protrude into the one or more channels from the exterior surface 9 of the inner hollow structure 7 (as shown in FIG. 4), from the interior surface 6 of the outer hollow structure 5, or from both these surfaces 6, 9 without exceeding the scope of the present disclosure. The shape of the features 40 may be any shape including, without limitation, cylindrical, oblong, or angled. The number of features 40, the shape of the features 40, and the positioning of the features 40 are selected so that they provide the desired flow and/or mixing of the heat transfer fluid 27 in the channel(s) 25. In FIG. 5, the flow path (→) provides mixing of the fluid in the presence of the features 40 that protrude into the one or more channels 25. The heat transfer fluid 27 may comprise any type of heat transfer liquid, including without limitation, water, a glycol, or a water/glycol mixture.

When the inner hollow structure 7 is formed of a thermally conductive polymeric material that comprises a composite polymeric material, this composite polymeric material generally consists of, consists essentially of, or comprises a thermally conductive filler dispersed in a polymeric matrix. This thermally conductive filler may also exhibit a low level of electrical conductivity in order to assist in the electrical isolation of the batteries. For the purpose of this disclosure, a low level of electrical conductivity exhibited by the thermally conductive filler is defined as being on the order of 9.9×10⁵ S/m or less; alternatively, on the order of 9.9×10⁴ S/m or less. Alternatively, the electrical conductivity of the thermally conductive filler is low enough that the filler is classified as an electrical insulator.

The thermally conductive filler comprises a plurality of particles having a composition comprising boron nitride, alumina, aluminum nitride, silicon nitride, silicon carbide, graphene, graphite, carbon nanotubes (single-walled or multi-walled), or a mixture thereof. The particles may have any feasible shape including without limitation, spherical, flat (e.g., platelets), irregular, or oblong (e.g., fibers). The particles may also be described as being in any feasible crystalline form that provides for thermal conductivity. Alternatively, boron nitride when used as the conductive filler provides a level of thermal conductivity and electric insulation desirable for use in many applications. Boron nitride (BN) particles when used as the thermally conductive filler may comprise either a hexagonal crystallographic form (H-BN) or a cubic crystallographic form (C-BN); alternatively, the thermally conductive filler is H-BN.

The polymeric matrix may comprise an elastomer, a thermoplastic, or a thermoplastic elastomer (TPE) having a Shore A hardness that is in the range of about 40 to 100 or a Shore D hardness that is in the range of 20 to about 75. Alternatively, the polymeric matrix is a thermoplastic elastomer (TPE) having a Shore A hardness in the range of about 50 to about 90 or a Shore D hardness of about 45 to about 75; alternatively, a Shore A hardness in the range from about 70 to about 80. The Shore A hardness and/or the Shore D hardness may be measured using a Shore® (Durometer) test according to ASTM D22440 00, ISO 7619 and ISO 868; DIN 53505; and/or JIS K 6301, which has been superseded by JIS K 6253. Alternatively, the polymeric matrix is a thermoplastic having a Shore D hardness in the range of about 60 to 75.

According to one aspect of the present disclosure, the composition of the composite polymeric material 70 comprises a plurality of boron nitride particles dispersed in a thermoplastic elastomer (TPE) having a Shore A hardness in the range of about 70 to about 80.

The thermally conductive filler may be dispersed in the polymeric matrix using any mixing technique known to disperse solid particles into a liquid polymer. Upon mixing, the thermally conductive filler comprises between about 5 wt. % to about 30 wt. % of the overall weight of the composite polymeric material. Alternatively, the thermally conductive filler comprises between about 5 wt. % to about 25 wt. %; alternatively, between about 10 wt. % to about 20 wt. % of the overall weight of the composite polymeric material.

The outer hollow structure 5 is formed of a “hard” polymer in order to provide for physical or mechanical protection of the battery pack. The outer hollow structure may comprise, without limitation high density polyethylene (HDPE), polypropylene (PP), polyamide (PA), or a combination thereof either as copolymers, a polymeric blend/mixture or as a multi-layered structure or composite. The outer hollow structure may further include a plurality of fillers, such as fiber or particle reinforcement (e.g., glass, carbon, etc.), in order to enhance structural performance and provide for thermal runaway mitigation.

According to another aspect of the present disclosure, a battery pack with thermal management is provided. Referring once again to FIGS. 1 to 5, the battery pack 1 generally comprises at least one battery 10 and a double-wall enclosure 3 configured as previously described and as further defined herein. This double-wall enclosure 3 may be used to provide for the thermal management of at least one battery 10 in an electric vehicle (EV) or hybrid electric vehicle (HEV).

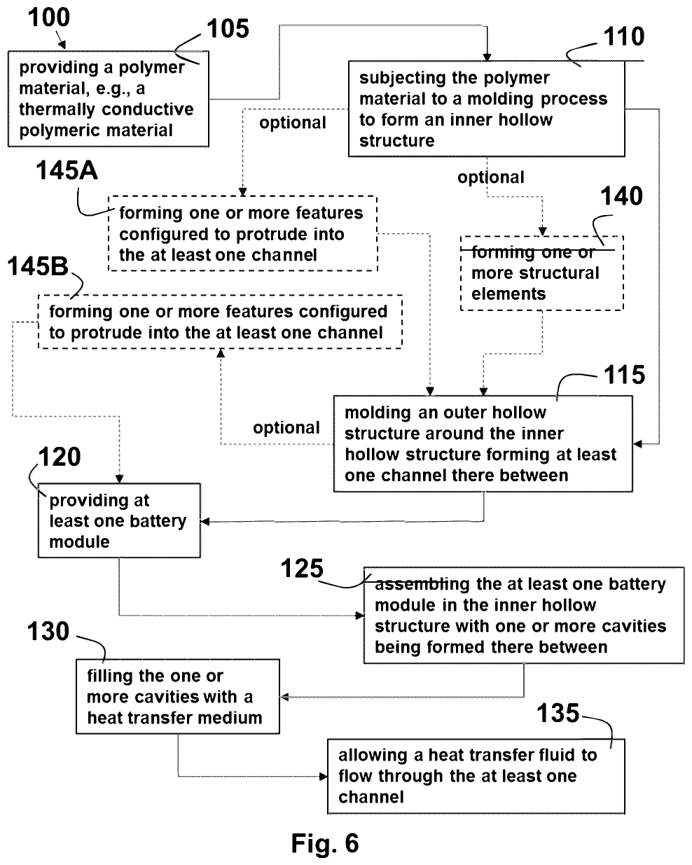

Referring now to FIG. 6, according to another aspect of the present disclosure, a process 100 for forming a battery pack as previously described and as further defined herein is provided. This process 100 generally comprises the steps of providing 105 a polymer material; molding 110 an inner hollow structure from the polymer material having an external and internal surface; molding 115 an outer hollow structure having an interior surface that surrounds the external surface of the inner hollow structure, wherein the external surface of the inner hollow structure either contacts the interior surface of the outer hollow structure or forms at least one channel with the interior surface of the outer hollow structure; providing 120 at least one battery; assembling 125 the at least one battery in the inner hollow structure with one or more cavities being formed between the battery and the internal surface of the inner hollow structure; filling 130 the one or more cavities with a heat transfer medium, and allowing 135 a heat transfer fluid to flow through the at least one channel located between the interior surface of the outer hollow structure and the external surface of the inner hollow structure. The molding process 110, 115 utilized this process 100 may be selected as one from the group consisting of blow molding, injection molding, compression molding, rotational molding; or a combination thereof

When desirable this process 100 may further comprise forming 140 one or more structural elements present in the inner hollow structure in order to assist in supporting the weight of the batteries or battery modules or to act as a bump stop for the placement and retention of such batteries. These structural elements may be formed by a molding process, such as for example, blow molding utilizing “Ship-in-a-Bottle” (SIB) technology or “Tank Advanced Process Technology”(TAPT).

When desirable the process 100 may further comprise forming 145A, 145B one or more features that protrude into the at least one channel from the interior surface of the outer hollow structure 145B or from the external surface of the inner hollow structure 145A, in order to increase stiffness and/or to promote fluid mixing by directing the flow of the fluid. This additional forming step 145A, 145B is generally incorporated into the molding process 110, 115 by including an additional step during the molding process, such as through the use of 3-D printing or the positioning of inserts within the mold.

When desirable the step of assembling 125 the at least one battery in the inner hollow structure may be done in conjunction with molding 110 the inner hollow structure through the use of the “Ship-in-a-Bottle” technique or Tank Advanced Process Technology (TAPT) during blow molding. Alternatively, the assembling 125 may include placement of one or more battery modules into an inner hollow structure that has an opening therein. After placement of the batteries, this opening is then closed to form a “leak-free” hollow structure through the use of one more of ultrasonic welding, spin welding, vibration welding, hot plate welding, infrared welding, laser welding, and over-molding techniques. The one or more battery modules placed into the inner hollow structure may comprise any known cell format, including, without limitation, prismatic, cylindrical, pouch, or a combination thereof.

One skilled in the art will understand that the process steps in the method as described above and in FIG. 6, as well as those further defined herein are not limited to being performed in the sequential order listed, but rather the process steps may be performed in any desired or required order based upon the selection of the materials and the manufacturing equipment and techniques chosen for processing the materials. Each of the process steps may be conducted consecutively or simultaneously, such as a step being combined with and run in conjunction with or as part of another of the process steps. Alternatively, when desirable, the process steps may be conducted in the sequential order provided.

Those skilled-in-the-art, in light of the present disclosure, will appreciate that many changes can be made in the specific embodiments which are disclosed herein and still obtain alike or similar result without departing from or exceeding the spirit or scope of the disclosure. One skilled in the art will further understand that any properties reported herein represent properties that are routinely measured and can be obtained by multiple different methods. The methods described herein represent one such method and other methods may be utilized without exceeding the scope of the present disclosure.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. Thus, the invention is not limited in its execution to the abovementioned preferred exemplary embodiments. Rather, a number of variants are conceivable that make use of the illustrated solution even in the form of fundamentally different embodiments. All such modifications and variations are within the scope of the invention as determined by the appended claims when interpreted in accordance with the breadth to which they are fairly, legally, and equitably entitled.

1. A double-wall enclosure for thermal management of a battery pack having one or more battery modules, the enclosure comprising:
an inner hollow structure having an internal and external surface; the inner hollow structure configured to receive the one or more battery modules therein; and
an outer hollow structure having an interior surface, wherein the external surface of the inner hollow structure either contacts the interior surface of the outer hollow structure or forms at least one channel with the interior surface of the outer hollow structure through which a heat transfer fluid flows;
wherein the inner hollow structure comprises a polymer material, such that the inner hollow structure is in thermal contact with the heat transfer fluid in order to provide for the thermal management of the battery pack.

2. The enclosure according to claim 1, wherein the inner hollow structure comprises a wall thickness that is in the range of about 0.3 millimeters (mm) to about 2.5 mm;
wherein the outer hollow structure comprises a wall thickness that is in the range of about 1.0 mm to about 5.0 mm.

3. The enclosure according to claim 1, herein one or more cavities are formed between the one or more battery modules and the internal surface of the inner hollow structure;
wherein the one or more cavities are at least partially filled with a heat transfer medium.

4. The enclosure according to claim 3, wherein the heat transfer medium in the one or more cavities is a single phase dielectric fluid, a multiphase dielectric fluid, a phase change material, or a combination thereof;
wherein the heat transfer fluid in the at least one channel is water, a glycol, or a water/glycol mixture.

5. The enclosure according to claim 1, wherein the polymer material comprises an elastomer, a thermoplastic, a thermoplastic elastomer (TPE), or a combination thereof.

6. The enclosure according to claim 1, wherein the polymer material has a Shore A hardness that is in the range of about 40 to 100 or a Shore D hardness that is in the range of 20 to about 75.

7. The enclosure according to claim 1, wherein the polymer material is a thermally conductive polymeric material.

8. The enclosure according to claim 7, wherein the polymer material is a thermally conductive polymeric material that comprises a polymer having intrinsic thermal conductivity; a blend of polymers, wherein one or more of the polymers in the blend has intrinsic thermal conductivity; a composite polymeric material having at least one polymer configured as a polymeric matrix with a thermally conductive filler dispersed therein; or a combination thereof.

9. The enclosure according to claim 8, wherein the thermally conductive filler comprises a plurality of particles having a composition selected from the group consisting of boron nitride, alumina, aluminum nitride, silicon nitride, silicon carbide, graphene, carbon nanotubes, or a mixture thereof.

10. The enclosure according to claim 1, wherein the composition of the polymer material comprises a composite polymeric material having a plurality of boron nitride particles dispersed in a thermoplastic elastomer (TPE) matrix having a Shore A hardness in the range of about 70 to about 80.

11. The enclosure according to claim 1, wherein the outer hollow structure comprises high density polyethylene (HDPE). polypropylene (PP), polyamide (PA), or a combination thereof either as copolymers, a polymeric blend/mixture, or as a multi-layered structure or composite.

12. The enclosure according to claim 1, wherein the at least one channel is located relative to the one or more battery modules either above, below, on at least one side, or a combination thereof.

13. The enclosure according to claim 1, wherein the inner hollow structure includes one or more structural elements configured to support the weight of the one or more battery modules and/or act as a bump stop configured to assist in battery placement and retention;
wherein the one or more structural elements are either formed integrally with the inner hollow structure or provided as an insert that is joined to the inner hollow structure.

14. The enclosure according to claim 1, wherein at least one of the external surface of the inner hollow structure or the interior surface of the outer hollow structure includes one or more features configured to increase stiffness and/or to promote fluid mixing by directing the flow of the fluid;
wherein at least one of the features protrudes into the at least one channel.

15. The enclosure according to claim 1, wherein at least a portion of the external surface of the inner hollow structure that forms a portion of the at least one channel is flat, such that at least 50% surface contact is maintained with the heat transfer fluid in the at least one channel.

16. The enclosure according to claim 1, wherein the inner hollow structure and the outer hollow structure results in less than about 15% volume change upon allowing the heat transfer fluid to flow through the at least one channel.

17. The enclosure according to claim 7, wherein the thermally conductive polymeric material comprises a composite polymeric material having a polymeric matrix with a thermally conductive filler dispersed therein, such that the thermally conductive filler comprises between about 5 wt. % to about 25 wt. % of the overall weight of the composite polymeric material.

18. A battery pack with thermal management, wherein the battery pack comprises:
at least one battery; and
a double-wall enclosure according to any of claims 1; wherein the double-wall enclosure comprises an inner hollow structure having an internal and external surface; the inner hollow structure having one or more battery modules located therein;
and an outer hollow structure having an interior surface, wherein the external surface of the inner hollow structure either contacts the interior surface of the outer hollow structure or forms at least one channel with the interior surface of the outer hollow structure through which a heat transfer fluid flows;
wherein the inner hollow structure comprises a polymer material, such that the inner hollow structure is in thermal contact with the heat transfer fluid in order to provide for the thermal management of the battery pack.

19. The battery pack according to claim 18, wherein the polymer material comprises a thermally conductive polymeric material.

20. The battery pack according to claim 19, wherein thermally conductive polymeric material comprises a composite polymeric material having a polymeric matrix with a thermally conductive filler dispersed therein;
wherein the thermally conductive filler comprises a plurality of particles having a composition selected from the group consisting of boron nitride, alumina, silicon nitride, graphene, carbon nanotubes, or a mixture thereof;
wherein the polymeric matrix is an elastomer, a thermoplastic, or a thermoplastic elastomer (TPE) having a Shore A hardness that is in the range of about 40 to 100 or a Shore D hardness that is in the range of 20 to about 75;
wherein the thermally conductive filler comprises between about 5 wt. % to about 25 wt. % of the overall weight of the composite polymeric material.

21. (canceled)
